(19) United States
(12) Patent Application Publication
(10) Pub. No.: US 2016/0133944 A1
(43) Pub. Date: May 12, 2016

(54) CATALYST LAYER WITH THROUGH-HOLES FOR FUEL CELLS

(71) Applicants: Madhu Saha, Vancouver (CA); Tatyana Soboleva, North Vancouver (CA); Juergen Stumper, Vancouver (CA); Jingwei Hu, New Westminster (CA)

(72) Inventors: Madhu Saha, Vancouver (CA); Tatyana Soboleva, North Vancouver (CA); Juergen Stumper, Vancouver (CA); Jingwei Hu, New Westminster (CA)

(73) Assignees: FORD MOTOR COMPANY, Dearborn, MI (US); DAIMLER AG, Stuttgart (DE)

(21) Appl. No.: 14/933,009

(22) Filed: Nov. 5, 2015

Related U.S. Application Data
(60) Provisional application No. 62/077,128, filed on Nov. 7, 2014.

(51) Int. Cl. H01M 4/86; H01M 8/241; H01M 8/1018

(52) U.S. Cl. CPC H01M 4/8626; H01M 8/1018; H01M 8/241; H01M 2004/8689; H01M 2008/1095; H01M 2300/0082

(57) ABSTRACT

The performance of solid polymer electrolyte fuel cell stacks can be improved by incorporating an appropriate set of through-holes in the catalyst layers, and particularly in the cathode catalyst layers. Intaglio methods suitable for manufacturing catalyst layers with through-holes are disclosed.

### BACKGROUND

1. Field of the Invention

The present invention pertains to solid polymer electrolyte fuel cell stacks comprising electrodes with through-holes in the catalyst layers. In addition, the invention relates to intaglio methods for making catalyst layers with through-holes.

2. Description of the Related Art

Sustained research and development effort continues on fuel cells because of the energy efficiency and environmental benefits they can potentially provide. Solid polymer electrolyte fuel cells show particular potential for consideration as power supplies in traction applications, e.g. automotive. However, various challenges remain in improving performance and cost before fuel cells are widely adopted for automotive applications in particular. One such challenge is to improve the rate capability of the cathode which presently limits the performance of these fuel cells.

Solid polymer electrolyte fuel cells electrochemically convert fuel (typically hydrogen) and oxidant (e.g. oxygen or air) to generate electric power. They generally employ a proton conducting polymer membrane electrolyte between two porous electrodes, namely a cathode and an anode. In operation, hydrogen is oxidized at the anode to create a hydrogen ion (proton) and an electron. The former is transported through the proton conducting polymer electrolyte to the cathode, while the latter is transported to the cathode through an external circuit thereby providing useful electrical power. At the cathode, oxygen is reduced and is combined with the proton and electron to create water. This reaction at the cathode is known as the oxygen reduction reaction. Appropriate catalyst compositions (typically supported platinum or platinum alloy compositions) are employed at each electrode to increase the reaction rate. The ability of the fuel cell to generate electrical power not only depends on how rapidly the oxygen reduction reaction can occur at the catalyst interface but also on how rapidly the reactants can be provided to the interface and how rapidly the by-product water can be removed therefrom. The mass transport properties of the cathode are those properties associated with moving the mass of reactants to and the mass of by-products from the cathode. Improving these mass transport properties can lead to improvements in the performance of the cathode.

In the manufacture of solid polymer electrolyte fuel cells, the cathode and anode electrodes may be coated directly onto the polymer membrane electrolyte to create a structure known as a catalyst coated membrane (CCM). Porous gas diffusion layers (GDLs) are usually employed adjacent the two electrodes to assist in diffusing the reactant gases evenly to the electrodes. Further, an anode flow field plate and a cathode flow field plate, each comprising numerous fluid distribution channels for the reactants, are provided adjacent the anode and cathode GDLs respectively to distribute reactants to the respective electrodes and to remove by-products of the electrochemical reactions taking place within the fuel cell. Water is the primary by-product in a cell operating on hydrogen and air reactants. Because the output voltage of a single cell is of order of 1V, a plurality of cells is usually stacked together in series for commercial applications. In such a stack, the anode flow field plate of one cell is thus adjacent to the cathode flow field plate of the adjacent cell. For assembly purposes, a set of anode flow field plates is often bonded to a corresponding set of cathode flow field plates prior to assembling the stack. A bonded pair of an anode and cathode flow field plates is known as a bipolar plate assembly. Fuel cell stacks can be further connected in arrays of interconnected stacks in series and/or parallel for use in automotive applications and the like.

Numerous varied approaches have been tried in the art to improve the performance of the fuel cell electrodes, and particularly that of the cathode, in order to improve the performance of a fuel cell stack. In some of these approaches, certain specific passageways and/or other open features were engineered into the electrodes. For instance, US20110165496 discloses a fuel cell electrode assembly which includes a substrate and a plurality of catalyst regions supported on the substrate to provide a passage way formed between the catalyst regions for passing fuel cell reactants, at least a portion of the plurality of catalyst regions including a number of atomic layers of catalyst metals. In certain instances, the number of atomic layers of catalyst metals is greater than zero and less than 300. Further, JP2006024556 discloses a fuel cell in which catalyst layers are formed on both sides of an ion conductive electrolyte membrane and a plurality of through holes penetrate at least one of the catalyst layers. However, the maximum output power density of the individual fuel cells tested was less than 350 mW/cm².

Notwithstanding the efforts made in the art to date, there still remains a need for improvement in fuel cell performance, including the rate capability of the fuel cell electrodes. The present invention fulfills this and other needs.

### SUMMARY

Surprisingly, the performance of a solid polymer electrolyte fuel cell stack can be significantly improved by incorporating a plurality of through-holes, in an appropriate manner, in the cathode catalyst layers of the cells in the stack. The presence of through-holes having suitable characteristics and arranged in a suitable pattern is believed to lead to improved mass transport in the catalyst layers which is particularly important in the cathode catalyst layer. And certain intaglio methods have been developed which provide practical means for preparing CCMs whose electrodes include such through-holes. The invention is intended for fuel cell stacks and is particularly suitable for automotive applications in which the fuel cell system is the traction power supply for the vehicle.

The intaglio methods of the invention thus involve making a catalyst coated membrane comprising a solid polymer electrolyte membrane coated with a catalyst layer comprising a plurality of through-holes. Specifically, the methods comprise: providing a printing surface comprising a depression and a plurality of pillars arranged in a pattern within the depression, filling the depression with an ink comprising the catalyst, drying the ink in the depression of the printing surface, contacting a sheet of the solid polymer electrolyte to the printing surface, and applying pressure and heat to the contacted solid polymer electrolyte and printing surface. This results in a catalyst coated membrane in which the plurality of through-holes are located in accordance with the locations of the plurality of pillars.

The pillars can be readily shaped and patterned so as to conform to preferred characteristics desired for the through-holes in the produced catalyst layers. For instance, the plurality of pillars can be shaped as right circular cylinders and can have an equivalent diameter in the range from about 1 to 500 micrometers. Further, it is possible to provide a plurality of pillars in a pattern with the pillars spaced apart with an average spacing of from about 4 to 1000 micrometers. Further still, the area occupied by the plurality of the pillars can be equivalent to about 1 to 20% of the area of the cathode layer produced and the ratio of the equivalent diameter of the pillars to the average spacing of the pillars can be about 0.1 to 0.5.

In the intaglio methods, the printing surface employed can be a plate or a drum. The filling step employed can comprise inkjet printing. Further, the filling step can comprise overfilling the depression with the ink and squeegeeing away excess ink from the surfaces of the plurality of pillars and the printing surface surrounding the depression. Further still, pressure in the range from about 5 to 16 bar and heat in the range from about 100 to 150° C. can be applied to the contacted solid polymer electrolyte and printing surface.

The method of the invention is suitable for producing coated catalyst layers from about 1.5 to 15 micrometers thick and comprising from about 0.01 to 0.5 mg/cm² of platinum catalyst.

The invention also comprises solid polymer electrolyte fuel cell stacks with improved performance with regards to power output capability. Such stacks comprise a series stack of solid polymer electrolyte fuel cells in which the solid polymer electrolyte fuel cells each comprise a catalyst coated membrane, an anode gas diffusion layer adjacent the anode layer of the catalyst coated membrane, and a cathode gas diffusion layer adjacent the cathode layer of the catalyst coated membrane. The catalyst coated membrane comprises a solid polymer electrolyte, an anode layer comprising anode catalyst coated on one side of the solid polymer electrolyte, and a cathode layer comprising anode catalyst coated on the other side of the solid polymer electrolyte, and is further characterized in that the cathode layer comprises a plurality of through-holes arranged in a pattern.

In certain embodiments of such stacks, the plurality of through-holes are shaped as right circular cylinders. The equivalent diameter of the through-holes can be in the range from about 1 to 500 micrometers. Further, the plurality of through-holes in the pattern can be spaced apart with an average spacing of from about 4 to 1000 micrometers. Further still, the plurality of through-holes can occupy about 1 to 20% of the area of the cathode catalyst layer. And further, the ratio of the equivalent diameter of the through-holes to the average spacing of the through-holes can be about 0.1 to 0.5

Also in certain embodiments, the coated catalyst layers can be from about 1.5 to 15 micrometers thick and can comprise from about 0.01 to 0.5 mg/cm² of platinum catalyst.

Benefits of the invention can then be obtained by operating such stacks by supplying fuel to the anode layers in the fuel cells at greater than ambient pressure, supplying oxidant to the cathode layers in the fuel cells at greater than ambient pressure, and drawing power at greater than 1 W/cm² from the fuel cells.

### BRIEF DESCRIPTION OF THE DRAWINGS

FIG. 1 shows an idealized isometric view of a catalyst layer of the invention and identifies the dimensions referred to in the modeling of the Examples.

FIGS. 2a and 2b compare the performance characteristics (based on modeling) of fuel cells comprising an inventive cathode catalyst layer to those of a conventional fuel cell. FIG. 2a plots the expected current densities at 0.5 V as a function of dimensions d₁ and d₂ for an array of through-holes in the catalyst layer. FIG. 2b plots the expected fuel cell voltages as a function of current density for a preferred inventive embodiment and a conventional fuel cell.

FIGS. 3a and 3b show SEM photographs of top views of a catalyst layer in the Examples in which an intaglio method was employed and inkjet printing was used for the filling step. FIG. 3b shows an enlarged view of a section in FIG. 3a.

FIG. 3c shows a SEM photograph of a top view of a catalyst layer in the Examples in which the catalyst layer was applied directly to the membrane electrolyte.

FIG. 4 compares polarization plots for representative inventive cells and for comparative cells in the Examples.

### DETAILED DESCRIPTION

Herein, in a quantitative context, the term “about” should be construed as being in the range up to plus 10% and down to minus 10%.

A through-hole, whether circular or non-circular, is considered to have an “equivalent diameter” which is defined as the diameter of a circular hole having the same open area as that of the through-hole.

With regards to dimensions such as spacing or average spacing between possibly irregularly shaped objects (e.g. through-holes, pillars), these dimensions are to be determined with respect to the centroids of the objects.

Intaglio refers to a variety of printing techniques in which the image to be printed is incised into a surface, thereby creating depressions in the surface. The incised areas or depressions are filled with the printing ink and the ink is then transferred to a desired article for printing by contacting the article to the incised surface and applying appropriate pressure.

The invention relates to solid polymer electrolyte fuel cell stacks comprising electrodes with through-holes in the catalyst layers and particularly to stacks in which the fuel cells comprise catalyst coated membranes. With the exception of these components, the construction of the fuel cells, and stacks thereof, can be any of the conventional constructions known to those in the art. In a preferred embodiment, the unit solid polymer electrolyte fuel cells making up the stack each comprise a catalyst coated membrane in which the cathode layer comprises a plurality of through-holes formed in accordance with the invention. Adjacent the cathode layer is a cathode gas diffusion layer (GDL) and adjacent the anode layer is an anode GDL. And adjacent one of the cathode and anode GDLs is an appropriately oriented bipolar plate assembly (comprising a bonded pair of anode and cathode flow field plates). Fuel cell stacks can then readily be made by stacking a desired number of these unit fuel cells.

Although certain aspects of the present invention can apply to either anode or cathode layers, incorporating an appropriate set of through-holes in the cathode catalyst layers of cells in a fuel cell stack can provide for significantly improved performance.

While conventional catalyst layers can have significant porosity, the pores therein are generally in the submicron size range and have a somewhat tortuous structure. This can limit mass transport in the layers, thereby resulting in increased cell resistance at higher current densities. As per the present invention however, providing a number of appropriately spaced, larger through-holes or “pores” allows for improved mass transport within the layers, e.g. improved reactant gas access to and improved water removal from the layers, and particularly in the case of the cathode layer where substantial water is formed as the by-product of the electrochemical reactions taking place within the cells. Provided properly, the presence of the through-holes can significantly improve mass transport without sacrificing an undue amount of electrode area otherwise occupied by catalyst and desirably adjacent the solid polymer membrane electrolyte. Hence an overall benefit in fuel cell performance can be obtained.

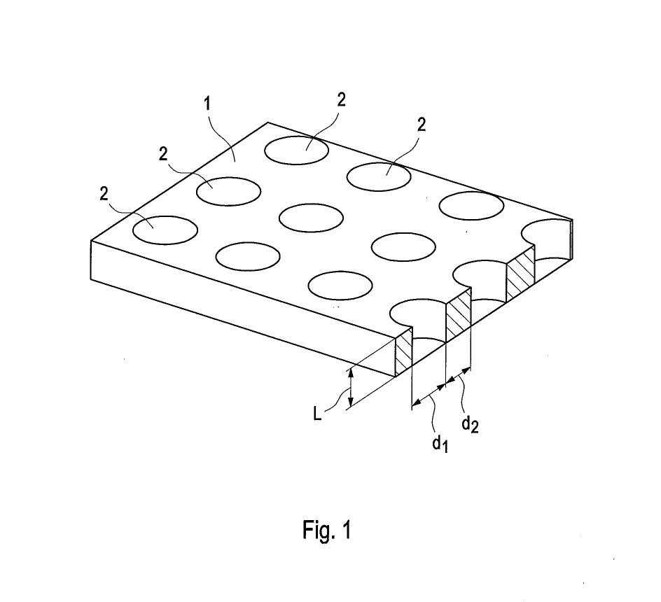

An example of a suitable pattern of through-holes for a catalyst layer is shown in the schematic of FIG. 1. Here, an isometric view of a partial section of planar, porous cathode catalyst layer 1 is shown and is an idealized representation of a catalyst layer of the invention. As shown in FIG. 1, cathode catalyst layer 1 comprises a square array of through-holes 2 shaped as right circular cylinders. The thickness of layer 1 is represented by dimension L. The equivalent diameter (actual diameter) of each of through-holes 2 is represented by d₁. The shortest distance between nearest-neighbour through-holes 2 in the array is represented by d₂. (These latter two dimensions are important dimensions employed in the modeling done in the Examples below.) The spacing between the centroids (or centres in this case for circular holes) of nearest-neighbour through-holes 2 is thus given by d₁+d₂ (and is the same as the average spacing for through-holes in a square array like that of FIG. 1).

As demonstrated in the Examples below, improved performance can be achieved when certain patterns of through-holes are employed in the cathode catalyst layers of otherwise conventional solid polymer electrolyte fuel cell stacks. Further, modeling demonstrates that improved performance can be expected to be achieved when the dimensions characterizing the through-hole patterns lie within certain ranges. For instance, improvement can be expected in embodiments in which the equivalent diameter of the through-holes is in the range from about 1 to 500 micrometers. Further, the average spacing of the through-holes in the pattern can be in the range from about 4 to 1000 micrometers. Further still, the ratio of the equivalent diameter of the through-holes to the average spacing thereof (i.e. d₁/(d₁+d₂)) can be from about 0.1 to 0.5. Benefits may be expected to be obtained for catalyst layers whose thickness is between about 1.5 and 15 micrometers thick and for those comprising platinum catalyst loadings in a range from about 0.1 to 0.5 mg/cm². And such benefits can be obtained from embodiments in which the numerous through-holes occupy only from about 1 to 20% of the area of the catalyst layer.

The selection of appropriate through-hole and pattern characteristics for purposes of achieving a desirable performance improvement in a given fuel cell stack is to some extent specific to the other characteristics of that stack. However, guidance for that selection can be gleaned from the actual embodiments and the modeling discussion and results provided in the Examples below. With that and other knowledge common to those skilled in the art, it is expected that appropriate through-hole and pattern characteristics can readily be determined.

While more easily modeled and possible more easily manufactured, embodiments of the invention are not limited to the through-hole arrangement depicted in FIG. 1. As will also be apparent to those in the art, suitable embodiments can include those in which the through-holes are not right circular cylinders and/or not in a square array. Instead, embodiments can comprise various alternative through-holes shapes and/or array configurations (e.g. hexagonal). Further, it is well known that conditions over the electrode surfaces are typically not uniform during stack operation and thus it may be advantageous to consider employing through-hole patterns that are not uniform over the surface of the entire catalyst layer.

The present invention also includes intaglio methods for making catalyst coated membranes in which one or both catalyst layers comprise through-holes generally. Although the schematic shown in FIG. 1 may look relatively simple structurally and hence straightforward to prepare on a membrane electrolyte, it is actually quite challenging to provide such a coating with reasonably well defined, discrete features. The dimensions involved are small (micrometer range) and the coatings involve the use of slurries comprising tiny particulates (as opposed to being uniform inks). Further, the membrane electrolyte upon which the coating is applied is not a dimensionally stable surface (e.g. swells or distorts when exposed to certain liquids).

The present intaglio methods share some similarities to those employed for making high quality paper prints. For instance, suitable printing surfaces include plates or drums. And generally, the methods comprise preparing a printing surface with an appropriately patterned depression formed therein, filling the depression with an appropriate fill, contacting a sheet to the printing surface, and applying pressure thereby transferring the fill to the contacting sheet.

Here though, certain polymer materials may be more suitable for use as printing surfaces since they can allow for easy transfer of the dried catalyst ink in the depression therein onto the solid polymer sheet. For instance, polydimethylsiloxane polymer was used in the Examples below. In order to form a desired through-hole pattern in the product, the depression in the printing surface comprises a complementary pattern of pillars. Polymeric printing surfaces comprising such depressions can be prepared by molding or machining a polymer block.

In the present methods, the depression of the printing surface is then filled with catalyst ink. This can be done for instance using inkjet printing, in single or multiple steps, and need not involve overfilling the depression. Alternatively, the depression can be overfilled with catalyst ink (in a variety of manners) and the excess ink then squeegeed away from the surfaces of the pillars and printing surface surrounding the depression. Thereafter, in the present methods, the ink is then dried in the depression.

After the catalyst ink in the printing surface depression has been dried, a sheet of solid polymer electrolyte is contacted to the printing surface. Heat (e.g. in the range from about 100 to 150° C.) and pressure (e.g. in the range from about 5 to 16 bar) are applied to the contacted solid polymer electrolyte and printing surface. This causes the dried ink in the depression to transfer and bond to the electrolyte thereby making a catalyst coated membrane comprising the desired plurality of through-holes located in accordance with the locations of the plurality of pillars in the depression.

Using these intaglio methods, catalyst layers can be formed on solid polymer electrolyte membranes with a desired through-hole pattern. Features can be formed with reasonably well defined, discrete shapes with the desired dimensions.

The following Examples have been included to illustrate certain aspects of the invention but should not be construed as limiting in any way.

### EXAMPLES

Modeling

A 3D model was built to understand the effects of through-hole diameter and spacing on fuel cell performance in fuel cells with through-holes in the cathode catalyst layers. The model assumed a through-hole pattern as depicted in FIG. 1 and used the design parameters d₁ and d₂ (defined in FIG. 1) to characterize through-hole diameter and spacing.

The model considered the major transport phenomenon, i.e. gas transport, electron transport and proton transport. The model was built and solved using commercial software, namely COMSOL Multiphysics 4.2. The most important transport parameters in the model were: effective gas diffusivity in the solid phase of catalyst layer (the ratio between effective O₂ diffusivity in the catalyst layer and the O₂ bulk diffusivity, i.e. D/D0), effective proton conductivity in the solid phase of catalyst layer (σ_{p, eff}) and effective electron conductivity in the solid phase of catalyst layer (σ_{e, eff}). In the model, values for these important transport parameters were set based on typical measured values for conventional solid polymer electrolyte fuel cells. The set values used were: D/D0=0.1, σ_{p, eff}=0.2 S/m and σ_{e, eff}=20 S/m respectively.

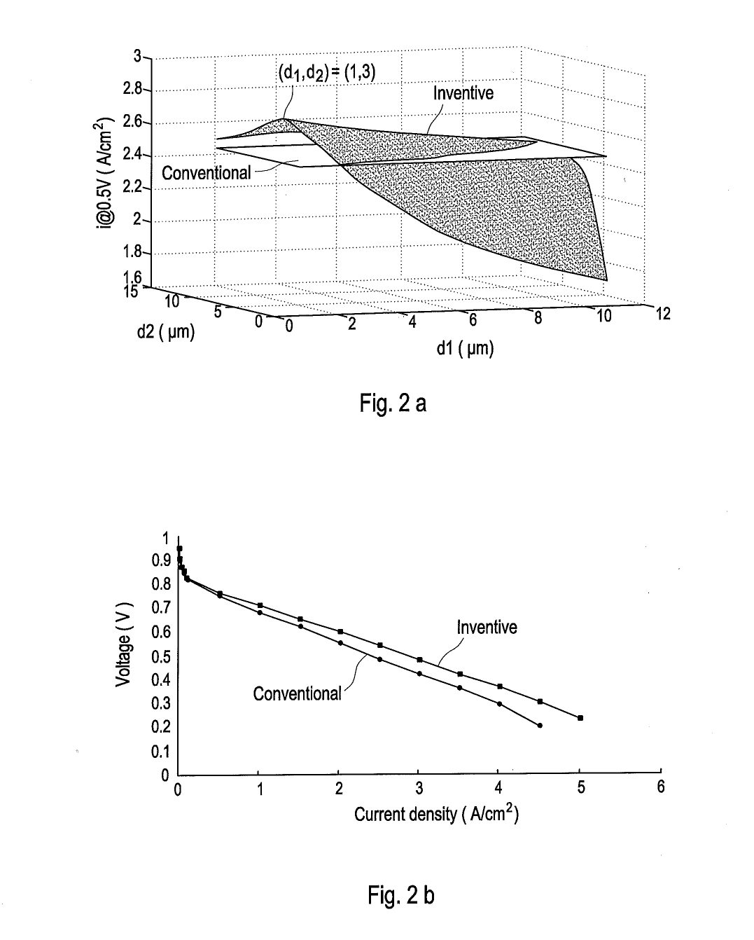

Based on such a model, FIGS. 2a and 2b compare the performance characteristics of fuel cells comprising an inventive cathode catalyst layer to those of a conventional fuel cell. FIG. 2a plots the expected current densities at 0.5 V as a function of dimensions d₁ and d₂ for an array of through-holes in the catalyst layer. (The current density of the conventional fuel cell is shown as a constant, planar surface for comparison.) FIG. 2b plots the expected fuel cell voltages as a function of current density for a preferred inventive embodiment and a conventional fuel cell.

As is evident from FIG. 2a, a relative maximum in current density occurs for values of d₁ and d₂ of about 1 and 3 μm respectively (i.e. through-hole diameter of about 1 μm and average spacing of about 3 μm). And this current density is substantially greater than that for the conventional fuel cell. In FIG. 2b, the full polarization curve (voltage versus current density) expected for this inventive embodiment is compared to the polarization curve for the conventional fuel cell.

Intaglio Methods

Using intaglio methods, catalyst coated membrane (CCM) samples were prepared with a plurality of through-holes in the catalyst layers. The goal was to prepare catalyst layers comprising an array of through-holes as depicted in FIG. 1 and in which d₁=d₂=50 micrometers.

In the following, the membrane electrolyte samples were made of perfluorosulfonic acid ionomer that was about 15 to 25 micrometer thick. The printing surface employed was molded out of polydimethylsiloxane polymer. The printing surface was 5 cm² in area and comprised a pillar pattern complementary to that shown in FIG. 1 and in which the diameter of the pillars was 50 μm, the spacing between pillars (equivalent to dimension d₂) was also 50 μm, and the depression in the printing surface was 10 μm deep.

The catalyst inks used were prepared by mixing about 50 wt % carbon supported platinum powder with about 20 wt % Nafion ionomer solution, 1-propanol, distilled water and ethylene glycol (EG). EG was added after an initial probe sonication and subsequent stirring. After addition of EG, the ink was stirred over for >24 hours before use.

In a first intaglio example, an inkjet printer was used to fill the depression in the printing surface. A commercial inkjet printer (Dimatix Materials Printer, DPM-2800 series) was used in which the printer head contained 16 nozzles, spaced 254 μm microns apart. The diameter of the nozzle openings was 20 μm. Inkjet cartridges producing 10 picolitre drops were used. A catalyst layer was then coated onto the membrane in multiple steps. In each step, the inkjet printer partially filled the depression with catalyst ink. Each partial layer was allowed to dry at 50° C. for a few minutes before printing the next partial layer. The ink was then dried in a vacuum oven at about 60 to 80° C. for a few hours. Thereafter, the dried catalyst ink in the printing surface depression was transferred to the membrane by contacting therewith under pressure in a heated press at about 100 to 150° C. and 5 to 16 bar. The final thickness or loading was controlled by estimating the catalyst loading applied using XRF after each sequential layer was applied.

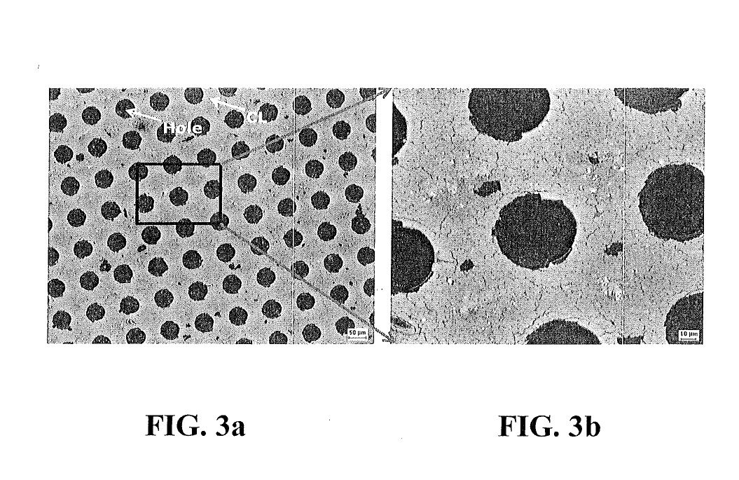

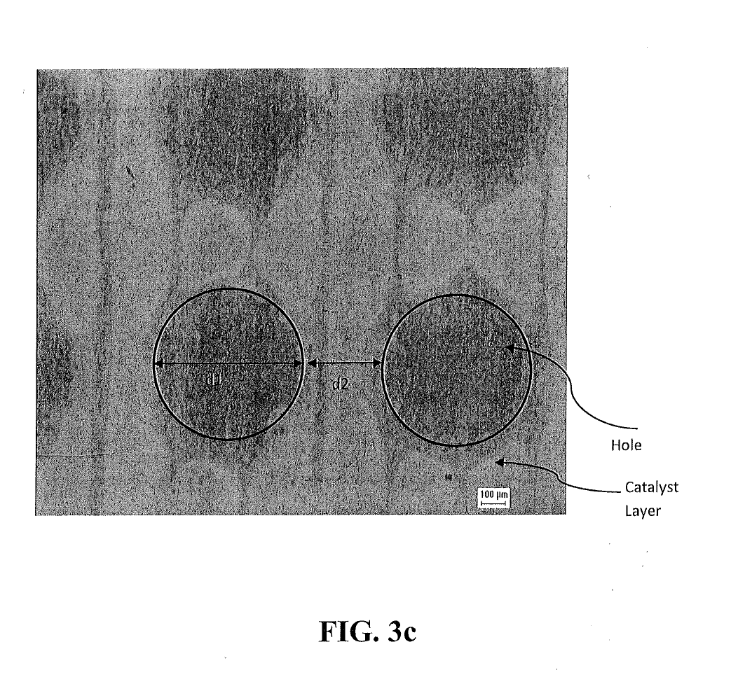

FIGS. 3a and 3b show SEM photographs of top views of the catalyst layer in this first intaglio example. FIG. 3b shows an enlarged view of a section in FIG. 3a. As can be seen in these figures, the applied catalyst layer had very well defined, discrete through-holes that were void of loose catalyst. The through-hole diameter was consistently about 51 μm. A cross-sectional photograph was taken (not shown) and showed that a uniform catalyst layer about 1.6 μm in thickness (about 45 μg/cm²) had been applied. Only a few thin cracks can be observed in the catalyst layer.

In a second intaglio example, a catalyst layer was coated onto a membrane electrolyte in a single step. Here, the depression in the printing surface was overfilled with catalyst ink and the excess ink then squeegeed away. The catalyst ink in the depression was dried as before and thereafter, transferred to the membrane under pressure in a heated press as before.

As before, SEM top and cross-sectional photographs were taken of the catalyst layer in this second intaglio example. Again, the applied catalyst layer had well defined, discrete through-holes that were void of catalyst. The through-hole diameter was consistently about 50 μm and the spacing d₂ between was about 51 μm. Again, the catalyst layer appeared uniform and was about 1.4 μm in thickness (about 26 μg/cm²) had been applied.

For comparison purposes, FIG. 3c shows a SEM photograph of a top view of a catalyst layer prepared later in the Examples in which the catalyst layer was applied directly to the membrane electrolyte by inkjet printing. The through-holes in FIG. 3c are about an order of magnitude larger than those in FIGS. 3a and b. And while a definite pattern has been created and the through-holes are mostly distinct and mostly void of catalyst, the quality of the applied layer in this regard is substantially inferior to that obtained via the intaglio methods. Significant and substantially larger cracks are seen in the spacing between through-holes.

Fuel Cell Testing

Four experimental fuel cells were made and tested in order to compare the cell performance obtained from CCMs having continuous cathode layers to those of the invention having through-holes in the cathode layers. This included two comparative fuel cells, as well as two fuel cells comprising different variations of the invention.

The CCMs had membrane electrolytes made of perfluorosulfonic acid ionomer that was about 25 micrometers thick. In each case, an anode layer was coated in a conventional manner on one side of the membrane. The anode catalyst was a conventional commercial carbon supported platinum (Pt/C) product comprising about 46% Pt by weight and the anode layer comprised about 0.05 to 0.1 mg/cm² of Pt.

The cathode catalyst was also conventional commercial carbon supported platinum (Pt/C) product comprising about 46% Pt by weight. In a conventionally made comparative CCM, the cathode layer was coated on the membrane in a conventional manner and with a Pt loading of 0.25 mg/cm². In the other CCMs prepared, the cathode layers were applied onto the membranes via direct inkjet printing and all with Pt loadings of 0.1 mg/cm². A comparative CCM with a continuous cathode catalyst layer was prepared with this loading. And two inventive CCMs with through-hole patterns like that depicted in FIG. 2a were prepared with this loading. Both inventive CCMs had a target d₂ dimension of 200 μm, but different target d₁ dimensions of 800 and 400 μm respectively. (FIG. 3c shows a SEM photograph of a top view of the catalyst layer with a target d₁ dimension of 800 μm. As mentioned above, the through-holes are of approximately the intended size and are mostly distinct and mostly void of catalyst, but the quality was inferior to that obtained using intaglio methods. Increased layer thickness was observed near the through-holes. As a result, the catalyst layer varied from about 1.7 to 2.5 μm in thickness.)

To fabricate individual test fuel cells, the preceding CCMs were sandwiched between anode and cathode gas diffusion layers (GDLs) comprising commercial carbon fibre paper from Freudenberg. Assemblies comprising the appropriate CCMs and anode and cathode GDLs were then bonded together under elevated temperature and pressure and placed between appropriate cathode and anode flow field plates having straight flow field channels in order to complete the experimental fuel cell constructions.

These fuel cells were first conditioned by operating at a current density of 1.0 A/cm², with hydrogen and air as the supplied reactants at high stoichiometries and at 100% relative humidity (RH), and at a temperature of about 70° C. overnight. Then, the performance characteristics of the fuel cells were obtained by measuring output voltage as a function of current density under a variety of operating conditions that would typically be experienced in automotive applications.

The construction of the fuel cells and the operating conditions involved in this Example are summarized below.

Fuel cells include:
Comparative cell C1: continuous cathode layer, conventionally coated, 0.25 mg/cm² Pt loading
Comparative cell C2: continuous cathode layer, inkjet coated, 0.1 mg/cm² Pt loading
Inventive cell I1: cathode layer with through-holes, (d₁, d₂)=(800 μm, 200 μm), inkjet coated, 0.1 mg/cm² Pt loading
Inventive cell I2, cathode layer with through-holes, (d₁, d₂)=(400 μm, 200 μm), inkjet coated, 0.1 mg/cm² Pt loading

Operating conditions include:
Normal: 68° C., variable RH at each point
Cold & Wet: 60° C., 100% RH
Hot & Wet: 90° C., 100% RH
Cold & Dry: 60° C., 30% RH
Hot & Dry: 90° C., 30% RH

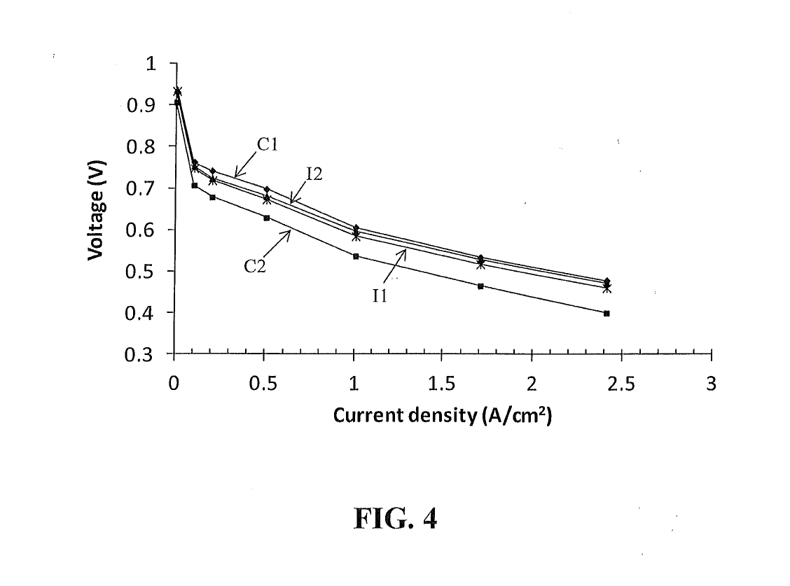

FIG. 4 compares polarization plots (voltage versus current density from 0 to over 2 A/cm²) for all the fuel cells under normal operating conditions. The difference in Pt loading between comparative cells C1 and C2 results in a substantial difference in performance between comparative cells C1 and C2. However, both inventive cells I1 and I2 show comparable performance to comparative cell C1 even though the former have much lower Pt loading.

Table 1 provides representative current density values under the other operating conditions tested for the various cells with 0.1 mg/cm² Pt loading. (The representative values were of current density obtained at 0.6 V.)

| Fuel | A/cm² @ 0.6 V | A/cm² @ 0.6 V | A/cm² @ 0.6 V | A/cm² @ 0.6 V |
|---|---|---|---|---|
| cell | Cold & Wet | Hot & Wet | Cold & Dry | Hot & Dry |
| C2 | 1.02 | 0.64 | 0.15 | 0.12 |
| I1 | 1.36 | 1.14 | 0.25 | 0.15 |
| I2 | 1.42 | 1.05 | 0.29 | 0.17 |

The two inventive cells I1 and I2 outperformed the comparative cell C2, and markedly so in some instances, under all operating conditions tested.

The preceding examples show that the intaglio methods of the invention can be used to produce CCMs with through-hole patterns in the cathode layers that have reasonable well defined and discrete features. The preceding examples also show that improved cell performance can be obtained using certain through-hole configurations. In particular, the cells can provide output power that is well in excess of 1 W/cm² of cathode layer under a variety of operating conditions applicable to automotive applications.

All of the above U.S. patents, U.S. patent application publications, U.S. patent applications, foreign patents, foreign patent applications and non-patent publications referred to in this specification, are incorporated herein by reference in their entirety.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings. For instance, the invention is not limited just to fuel cells operating on pure hydrogen fuel but also to fuel cells operating on any hydrogen containing fuel or fuels containing hydrogen and different contaminants, such as reformate which contains CO and methanol. Such modifications are to be considered within the purview and scope of the claims appended hereto.

What is claimed is:

1. An intaglio method of making a catalyst coated membrane, the catalyst coated membrane comprising a solid polymer electrolyte membrane coated with a catalyst layer, the catalyst layer comprising a plurality of through-holes, the method comprising:
providing a printing surface comprising a depression and a plurality of pillars arranged in a pattern within the depression;
filling the depression with an ink comprising the catalyst;
drying the ink in the depression of the printing surface;
contacting a sheet of the solid polymer electrolyte to the printing surface; and
applying pressure and heat to the contacted solid polymer electrolyte and printing surface, thereby making the catalyst coated membrane wherein the plurality of through-holes are located in accordance with the locations of the plurality of pillars in the printing surface.

2. The intaglio method of claim 1 wherein the printing surface is a plate or a drum.

3. The intaglio method of claim 1 wherein the plurality of pillars are shaped as right circular cylinders.

4. The intaglio method of claim 1 wherein the equivalent diameter of the pillars is in the range from about 1 to 500 micrometers.

5. The intaglio method of claim 1 wherein the plurality of pillars in the pattern are spaced apart with an average spacing of from about 4 to 1000 micrometers.

6. The intaglio method of claim 1 wherein the filling comprises inkjet printing.

7. The intaglio method of claim 1 wherein the filling comprises overfilling the depression with the ink and squeegeeing away excess ink from the surfaces of the plurality of pillars and the printing surface surrounding the depression.

8. The intaglio method of claim 1 comprising applying pressure to the contacted solid polymer electrolyte and printing surface in the range from about 5 to 16 bar.

9. The intaglio method of claim 1 comprising applying heat to the contacted solid polymer electrolyte and printing surface in the range from about 100 to 150° C.

10. The intaglio method of claim 1 wherein the coated catalyst layer is from about 1.5 to 15 micrometers thick.

11. The intaglio method of claim 1 wherein the coated catalyst layer comprises from about 0.01 to 0.5 mg/cm² of platinum catalyst.

12. A solid polymer electrolyte fuel cell stack comprising a series stack of solid polymer electrolyte fuel cells wherein the solid polymer electrolyte fuel cells each comprise:
a catalyst coated membrane comprising:
a solid polymer electrolyte;
an anode layer comprising anode catalyst coated on one side of the solid polymer electrolyte; and
a cathode layer comprising anode catalyst coated on the other side of the solid polymer electrolyte;
an anode gas diffusion layer adjacent the anode layer of the catalyst coated membrane;
a cathode gas diffusion layer adjacent the cathode layer of the catalyst coated membrane; and
characterized in that the cathode layer comprises a plurality of through-holes arranged in a pattern.

13. The solid polymer electrolyte fuel cell stack of claim 12 wherein the plurality of through-holes are shaped as right circular cylinders.

14. The solid polymer electrolyte fuel cell stack of claim 12 wherein the equivalent diameter of the through-holes is in the range from about 1 to 500 micrometers.

15. The solid polymer electrolyte fuel cell stack of claim 12 wherein the plurality of through-holes in the pattern are spaced apart with an average spacing of from about 4 to 1000 micrometers.

16. The solid polymer electrolyte fuel cell stack of claim 12 wherein the coated catalyst layer is from about 1.5 to 15 micrometers thick.

17. The solid polymer electrolyte fuel cell stack of claim 12 wherein the coated catalyst layer comprises from about 0.01 to 0.5 mg/cm² of platinum catalyst.

18. The solid polymer electrolyte fuel cell stack of claim 12 wherein the plurality of through-holes occupies about 1 to 20% of the area of the cathode layer.

19. The solid polymer electrolyte fuel cell stack of claim 12 wherein the ratio of the equivalent diameter of the through-holes to the average spacing of the through-holes is from about 0.1 to 0.5.

20. A method of operating the solid polymer electrolyte fuel cell stack of claim 12 comprising:
supplying fuel to the anode layers in the fuel cells at greater than ambient pressure;
supplying oxidant to the cathode layers in the fuel cells at greater than ambient pressure; and
drawing power at greater than 1 W/cm² from the fuel cells.
